(19) United States
(12) Patent Application Publication
(10) Pub. No.: US 2015/0321138 A1
(43) Pub. Date: Nov. 12, 2015

(54) METHOD FOR REMOVING ACID COMPOUNDS FROM A GASEOUS EFFLUENT USING AN ABSORBENT SOLUTION BASED ON 1,2-BIS(2-DIMETHYLAMINOETHOXY)ETHANE AND AN ACTIVATOR

(71) Applicant: IFP ENERGIES NOUVELLES, Rueil-Malmaison Cedex (FR)

(72) Inventors: Julien GRANDJEAN, Lyon (FR); Bruno DELFORT, Paris (FR); Dominique LE PENNEC, Orgerus (FR); Thierry HUARD, Saint Symphorien d'Ozon (FR)

(73) Assignee: IFP ENERGIES NOUVELLES, Rueil-Malmaison Cedex (FR)

(21) Appl. No.: 14/651,924

(22) PCT Filed: Nov. 25, 2013
(86) PCT No.: PCT/FR2013/052847

§ 371 Date: Jun. 12, 2015

(30) Foreign Application Priority Data
Dec. 13, 2012 (FR) 1203399

(51) Int. Cl. B01D 53/14; B01D 53/52; B01D 53/78

(52) U.S. Cl. CPC B01D 53/1462; B01D 53/1493; B01D 53/78; B01D 53/526; B01D 2252/2041; B01D 2252/20431; B01D 2252/602

(57) ABSTRACT

The invention relates to a method for removing acid compounds contained in a gaseous effluent having a CO₂ partial pressure greater than 200 mbar, using an aqueous solution comprising water, an amine comprising at least one primary or secondary amine function and the following diamine: 1,2-bis(2-dimethyl-aminoethoxy)ethane.

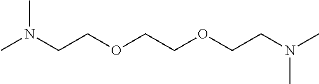

### FIELD OF THE INVENTION

The present invention relates to the field of gaseous effluent deacidizing methods. The invention is advantageously applied for treating gas of industrial origin and natural gas.

### BACKGROUND OF THE INVENTION

Absorption methods using an aqueous amine solution are commonly used for removing acid compounds (notably CO₂, H₂S, COS, CS₂, SO₂ and mercaptans) present in a gas. The gas is deacidized by contacting with the absorbent solution, then the absorbent solution is thermally regenerated. For example, document U.S. Pat. No. 6,852,144 describes a method of removing acid compounds from hydrocarbons. The method uses a water-N-methyldiethanolamine or water-triethanolamine absorbent solution with a high proportion of a compound belonging to the following group: piperazine and/or methylpiperazine and/or morpholine.

One limitation of the absorbent solutions commonly used in deacidizing applications is insufficient H₂S absorption selectivity in relation to CO₂. Indeed, in some natural gas deacidizing cases, selective H₂S removal is sought by limiting to the maximum CO₂ absorption. This constraint is particularly important for gases to be treated already having a CO₂ content that is less than or equal to the desired specification. A maximum H₂S absorption capacity is then sought with maximum H₂S absorption selectivity in relation to CO₂. This selectivity allows to recover an acid gas at the regenerator outlet having the highest H₂S concentration possible, which limits the size of the sulfur chain units downstream from the treatment and guarantees better operation. In some cases, an H₂S enrichment unit is necessary for concentrating the acid gas in H₂S. In this case, the most selective amine is also sought. Tertiary amines such as N-methyldiethanolamine (or MDEA) or hindered secondary amines exhibiting slow reaction kinetics with CO₂ are commonly used. For example, document U.S. Pat. No. 4,405,582 claims the use of an absorbent solution of a diaminoether at least one function of which is tertiary, selectively absorbing the H₂S contained in a gaseous effluent.

Another limitation of the absorbent solutions commonly used in total deacidizing applications is too slow CO₂ or COS capture kinetics. In cases where the desired CO₂ or COS specifications level is very high, the fastest possible reaction kinetics is sought so as to reduce the height of the absorption column. This equipment under pressure, typically between 40 bars and 70 bars, represents a significant part of the investment costs of the process.

Whether seeking maximum CO₂ and COS capture kinetics in a total deacidizing application, or minimum CO₂ capture kinetics in a selective application, it is always desirable to use an absorbent solution having the highest cyclic capacity possible. This cyclic capacity, denoted by Δα, corresponds to the loading difference (a designates the number of moles of absorbed acid compounds n_{acid gas} per kilogram of absorbent solution) between the absorbent solution fed to the absorption column and the absorbent solution discharged from the bottom of said column. Indeed, the higher the cyclic capacity of the absorbent solution, the more limited the absorbent solution flow rate required for deacidizing the gas to be treated. In gas treatment methods, reduction of the absorbent solution flow rate also has a great impact on the reduction of investments, notably as regards absorption column sizing.

Another essential aspect of industrial gas or fumes treatment operations using a solvent remains the regeneration of the separation agent. Regeneration through expansion and/or distillation and/or entrainment by a vaporized gas referred to as “stripping gas” is generally considered depending on the absorption type (physical and/or chemical).

Another limitation of the absorbent solutions commonly used today is the energy consumption necessary for solvent regeneration, which is too high.

It is well known to the person skilled in the art that the energy required for regeneration by distillation of an amine solution can be divided into three different items: the energy required for heating the solvent between the top and the bottom of the regenerator, the energy required for lowering the acid gas partial pressure in the regenerator by vaporization of a stripping gas, and the energy required for breaking the chemical bond between the amine and the CO₂.

These first two items are proportional to the absorbent solution flows to be circulated in the plant in order to achieve a given specification. In order to decrease the energy consumption linked with the regeneration of the solvent, the cyclic capacity of the solvent is therefore once again preferably maximized.

It is difficult to find compounds or a family of compounds allowing the various deacidizing processes to operate at lower operating costs (including the regeneration energy) and investment costs (including the cost of the absorption column).

It is well known to the person skilled in the art that formulations of tertiary amines or severely hindered secondary amines in admixture with a primary or secondary amine referred to as “activator” allow acid gas absorption capacities and CO₂ and COS absorption kinetics to be optimized. Among the applications of these formulations, document U.S. Pat. No. 6,852,144 notably illustrates the performances of CO₂ and COS removal from a natural gas by methyldiethanolamine and piperazine solutions, for various concentrations of these two amines.

It is also well known that using tertiary or hindered secondary amines without an activator allows selective H₂S removal. Patent U.S. Pat. No. 4,405,582 notably describes some amines of the diaminoether family exhibiting greatly improved absorption selectivities for H₂S over CO₂ in relation to the methyldiethanolamine commonly used for this application.

A limitation of these selective diaminoethers may appear when CO₂ absorption is sought for treating gases with much higher CO₂ contents than the desired specifications. There is then no guarantee that these diaminoethers associated with an “activator” exhibit improved CO₂ absorption capacities or CO₂ and COS absorption kinetics in relation to a formulation of methyldiethanolamine and of the same activator at identical mass concentrations.

Among the applications for diaminoethers, document FR-2,961,114 describes a method of removing the CO₂ contained in combustion fumes having a partial pressure below 200 mbar through contacting with an absorbent solution containing at least one diamine belonging to the 1,2-bis(2-aminoethoxy)ethane family. This document illustrates the gains in terms of CO₂ capture capacity and associated regeneration energy of these 30 wt. % activator-free amines for CO₂ partial pressures of 100 mbar in reference to a 30 wt. % monoethanolamine solution. However, there is no guarantee that these 1,2-bis(2-aminoethoxy)ethanes associated with an activator exhibit improved CO₂ absorption capacities for partial pressures above 200 mbar or CO₂ and COS absorption kinetics in relation to a formulation of methyldiethanolamine and of the same activator at identical mass concentrations.

The inventors have discovered that diaminoethers in general and those belonging to the general family of 1,2-bis(2-aminoethoxy)ethanes in particular are not equivalent in terms of performance for use in absorbent solution formulations with an activator for total deacidizing of gaseous effluents with a CO₂ partial pressure above 200 mbar. Surprisingly, activated 1,2-bis(2-dimethylaminoethoxy)ethane formulations distinguish themselves by their improved CO₂ absorption capacity for partial pressures above 200 mbar or CO₂ and COS absorption kinetics in relation to a formulation of methyldiethanolamine and of the same activator at identical mass concentrations.

The object of the invention thus relates to a method of removing acid compounds from a gaseous effluent having a CO₂ partial pressure above 200 mbar, using an aqueous solution containing water, at least one amine comprising at least one primary or secondary amine function and the following diamine:

### 1,2-bis(2-dimethyl-aminoethoxy)ethane

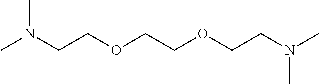

Using this diamine in an activated formulation according to the invention allows to obtain improved acid gas absorption capacities in relation to the reference amines in formulation with the same activators.

Furthermore, in the particular case of a gaseous effluent total deacidizing application where the absorbent solution contains the diamine according to the invention in admixture with a primary or secondary amine, the invention allows the COS and CO₂ absorption kinetics to be accelerated in relation to a MDEA solution containing the same proportion of primary or secondary amine. This COS and CO₂ absorption kinetics gain allows to save on the cost of the absorption column in cases where removal of these compounds at a high level of specifications is required.

### SUMMARY OF THE INVENTION

In general terms, the object of the present invention is a method for removing acid compounds contained in a gaseous effluent having a CO₂ partial pressure greater than 200 mbar, wherein an acid compound absorption stage is carried out by contacting the effluent with an absorbent solution comprising:
a—water,
b—the diamine 1,2-bis(2-dimethylaminoethoxy)ethane,
c—at least one activator selected from among the amines comprising at least one primary or secondary function.

According to the invention, the acid compound absorption stage can be carried out at a pressure ranging between 1 bar and 120 bars, and at a temperature ranging between 20° C. and 100° C.

According to one embodiment, after the absorption stage, a gaseous effluent depleted in acid compounds and an absorbent solution laden with acid compounds are obtained, and at least one stage of regenerating the absorbent solution laden with acid compounds is performed. The regeneration stage can be carried out at a pressure ranging between 1 bar and 10 bars, and at a temperature ranging between 100° C. and 180° C. The gaseous effluent can be selected from among natural gas, syngas, combustion fumes, refinery gas, biomass fermentation gas, cement plant gas and incinerator fumes.

Finally, the method can be implemented for selective H₂S removal from a gaseous effluent comprising H₂S and CO₂.

According to the invention, the absorbent solution can comprise between 10 and 90 wt. % of 1,2-bis(2-dimethylaminoethoxy)ethane, preferably between 20 and 60 wt. %, more preferably between 25 and 50 wt. %; the solution can comprise between 10 and 90 wt. % of water, preferably between 40 and 80 wt. %, more preferably between 50 and 75 wt. %; and the solution can comprise up to 30 wt. % of said activator, preferably less than 15 wt. %, preferably less than 10 wt. % and at least 0.5 wt. %.

The activator can for example be selected from among:
monoethanolamine,
N-butylethanolamine,
aminoethylethanolamine,
diglycolamine,
piperazine,
1-methylpiperazine,
2-methylpiperazine,
N-(2-hydroxyethyl)piperazine,
N-(2-aminoethyl)piperazine,
morpholine,
3-(methylamino)propylamine,
1,6-hexanediamine and all the diversely N-alkylated derivatives thereof such as, for example, N,N′-dimethyl-1,6-hexanediamine, N-methyl-1,6-hexanediamine or N,N′,N′-trimethyl-1,6-hexanediamine.

According to one embodiment, the solution can comprise an additional amine, said additional amine being a tertiary amine such as methyldiethanolamine, or a secondary amine having two tertiary carbons at nitrogen alpha position, or a secondary amine having at least one quaternary carbon at nitrogen alpha position. In this case, the solution can comprise between 10 and 90 wt. % of said additional amine, preferably between 10 and 50 wt. %, more preferably between 10 and 30 wt. %.

According to another embodiment, the solution can comprise a physical solvent selected from among methanol and sulfolane.

### BRIEF DESCRIPTION OF THE FIGURES

Other features and advantages of the invention will be clear from reading the description hereafter, with reference to the accompanying figures wherein:

FIG. 1 is a block diagram of an acid gas effluent treating method,

FIG. 2 illustrates in a non-exhaustive manner synthesis routes for 1,2-bis(2-dimethylaminoethoxy)ethane.

### DETAILED DESCRIPTION

The present invention relates to a method for removing acid compounds from a gaseous effluent with a CO₂ partial pressure greater than 200 mbar.

The method can be used for deacidizing the following gaseous effluents: natural gas, syngas, combustion fumes, refinery gas, biomass fermentation gas, cement plant gas and incinerator fumes. Besides CO₂, these gaseous effluents contain one or more of the following acid compounds: H₂S, mercaptans, COS, CS₂, SO₂.

The method according to the invention can be used for deacidizing a syngas. Syngas contains carbon monoxide CO, hydrogen H₂ (generally with an H_{z}/CO ratio of 2), water vapour (it is generally saturated therewith at the temperature at which washing is performed) and carbon dioxide CO₂ (of the order of 10%). The pressure generally ranges between 20 and 30 bars, but it can reach up to 70 bars. It also comprises sulfur-containing (H₂S, COS, etc.), nitrogen-containing (NH₃, HCN) and halogenated impurities.

The method according to the invention can be used for deacidizing a natural gas. Natural gas is predominantly made up of gaseous hydrocarbons, but it can contain some of the following acid compounds: CO₂, H₂S, mercaptans, COS, CS₂. These acid compounds are present in greatly variable proportions, up to 40% for CO₂ and H₂S. The temperature of the natural gas can range between 20° C. and 100° C. The pressure of the natural gas to be treated can range between 10 and 120 bars. The invention can be implemented to reach specifications generally imposed on the deacidized gas, which are 2% CO₂, or even 50 ppm CO₂ so as to subsequently carry out liquefaction of the natural gas, 4 ppm H₂S, and 10 to 50 ppm volume of total sulfur.

The formulations used in the method according to the invention, i.e. absorbent solutions of 1,2-bis(2-dimethylaminoethoxy)ethane and activators, have a higher CO₂ absorption capacity than the commonly used formulations. Indeed, these formulations have the specific feature of having very high loadings α=n_{acid gas}/nₐₘᵢₙₑ (α designating the ratio of the number of moles of acid compounds, n_{acid gas}, absorbed by an absorbent solution portion to the number of moles of amine, namine, contained in said absorbent solution portion) at high acid compound partial pressures, for example at a CO₂ partial pressure above 0.2 bar, by comparison with the conventionally used alkanolamines. Using an aqueous absorbent solution according to the invention allows to save on the investment cost and the regeneration cost of a deacidizing unit for a gas with high CO₂ partial pressures.

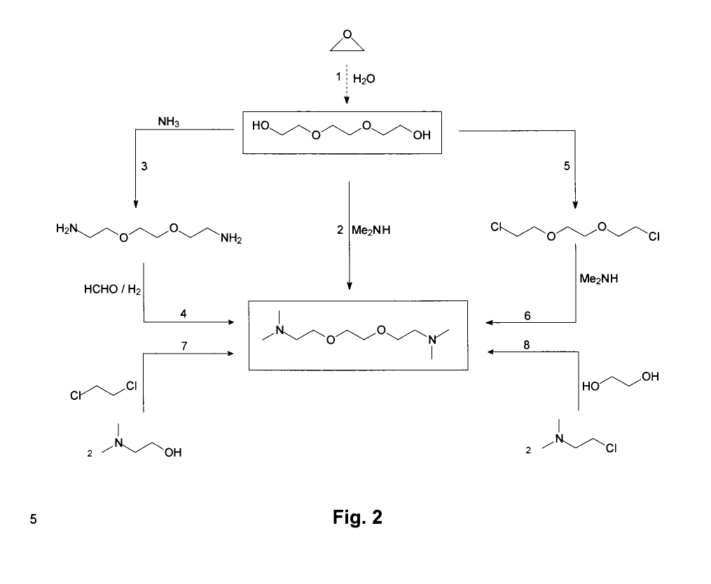

1,2-bis(2-dimethylaminoethoxy)ethane can be prepared using all the synthesis routes permitted by organic chemistry. FIG. 2 illustrates some of these routes in a non-exhaustive manner.

1,2-bis(2-dimethylaminoethoxy)ethane can be obtained through the reaction of dimethylamine on triethylene glycol according to a known condensation reaction (reaction 2). This reaction can for example take place in the presence of hydrogen and of a suitable catalyst under conditions abundantly mentioned in the literature.

Triethylene glycol, which is the precursor in this reaction, is generally obtained by ethylene oxide trimerization according to a conventional ring opening reaction in the presence of a water molecule (reaction 1). Triethylene glycol is an abundant and inexpensive industrial compound.

The compounds meeting the general formula can also be obtained first by the reaction of ammonia on triethylene glycol according to a known condensation reaction (reaction 3) leading to 1,2-bis(2-aminoethoxy)ethane also referred to as 1,8-diamino-3,6-dioxaoctane, the primary amine functions thereof being then N-alkylated through the reaction of formaldehyde in the presence of hydrogen and using generally a suitable catalyst (reaction 4) under conditions abundantly mentioned in the literature.

The compounds meeting the general formula can also be obtained first by the halogenation reaction, chlorination for example, of triethylene glycol to 1,2-bis(2-chloroethoxy)ethane (reaction 5) with a conventional chlorination agent such as hydrochloric acid or thionyl chloride for example, then by a condensation reaction (reaction 6) with dimethylamine.

The compounds meeting the general formula can also be obtained by the condensation reaction of dimethylamino-2-ethanol with a 1,2-dihalogenoethane such as 1,2-dichloroethane (reaction 7), or by the condensation reaction of a dimethylamino-2-halogenoethane such as a 2-chloro-N,N-dimethylethylamine, possibly in halogenohydrate form with ethylene glycol (reaction 8).

Composition of the Absorbent Solution

The absorbent solution used in the method according to the invention comprises:

a—water,
b—1,2-bis(2-dimethylaminoethoxy)ethane,
c—an activator selected from among the amines comprising at least one primary or secondary function.

According to the invention, the absorbent solution can comprise between 10 and 90 wt. % of 1,2-bis(2-dimethylaminoethoxy)ethane, preferably between 20 and 60 wt. %, more preferably between 25 and 50 wt. %; the solution can comprise between 10 and 90 wt. % of water, preferably between 40 and 80 wt. %, more preferably between 50 and 75 wt. %; and the solution can comprise up to 30 wt. % of said activator, preferably less than 15 wt. %, preferably less than 10 wt. % and at least 0.5 wt. %. The activator can be selected from among:
monoethanolamine,
N-butylethanolamine,
aminoethylethanolamine,
diglycolamine,
piperazine,
1-methylpiperazine,
2-methylpiperazine,
N-(2-hydroxyethyl)piperazine,
N-(2-aminoethyl)piperazine,
morpholine,
3-(methylamino)propylamine,
1,6-hexanediamine and all the diversely N-alkylated derivatives thereof such as, for example, N,N′-dimethyl-1,6-hexanediamine, N-methyl-1,6-hexanediamine or N,N′,N′-trimethyl-1,6-hexanediamine.
   d—According to one embodiment, the solution can comprise an additional amine, said additional amine being a tertiary amine such as methyldiethanolamine, or a secondary amine having two tertiary carbons at nitrogen alpha position, or a secondary amine having at least one quaternary carbon at nitrogen alpha position. In this case, the solution can comprise between 10 and 90 wt. % of said additional amine, preferably between 10 and 50 wt. %, more preferably between 10 and 30 wt. %.
   e—According to another embodiment, the absorbent solution can comprise a physical solvent selected from among methanol and sulfolane.

Method of Removing Acid Compounds from a Gaseous Effluent

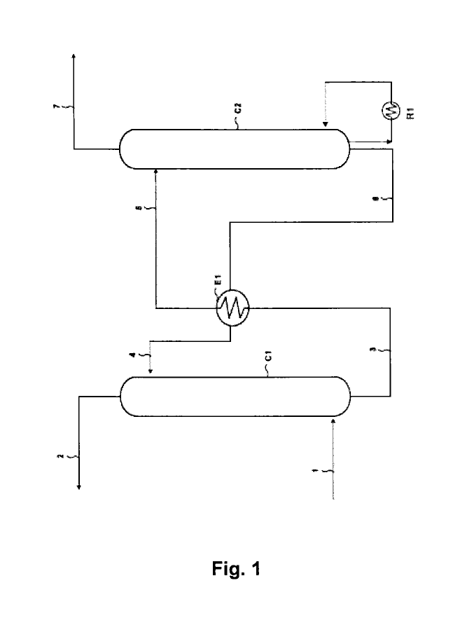

The method according to the invention for deacidizing a gaseous effluent from the aqueous solution described above is schematically implemented by carrying out an absorption stage followed by a regeneration stage, as shown in FIG. 1 for example.

With reference to FIG. 1, the absorption stage consists in contacting gaseous effluent 1 with absorbent solution 4. Gaseous effluent 1 is fed to the bottom of C1 and the absorbent solution is fed to the top of C1. Column C1 is provided with gas-liquid contacting means, for example a random packing, a structured packing or distillation trays. Upon contacting, the amine functions of the molecules of the absorbent solution react with the acid compounds contained in the effluent, so as to obtain a gaseous effluent depleted in acid compounds 2 discharged at the top of C1 and an absorbent solution enriched in acid compounds 3 discharged at the bottom of C1 in order to be regenerated.

The regeneration stage notably consists in heating, and optionally in expanding, the absorbent solution enriched in acid compounds in order to release the acid compounds in gas form. The absorbent solution enriched in acid compounds 3 is fed into heat exchanger E1 where it is heated by stream 6 coming from regeneration column C2. Solution 5 heated at the outlet of E1 is fed into regeneration column C2.

Regeneration column C2 is equipped with gas-liquid contacting internals such as trays, random or structured packings for example. The bottom of column C2 is fitted with a reboiler RI that provides the heat required for regeneration by vaporizing a fraction of the absorbent solution. In column C2, under the effect of contacting the absorbent solution flowing in through 5 with the vapour produced by the reboiler, the acid compounds are released in gas form and discharged at the top of C2 through line 7. Regenerated absorbent solution 6, i.e. depleted in acid compounds, is cooled in E1, then recycled to column C1 through line 4.

The acid compound absorption stage can be carried out at a pressure in C1 ranging between 1 and 120 bars, preferably between 20 and 100 bars for natural gas treatment, preferably between 1 and 3 bars for industrial fumes treatment, and at a temperature in C1 ranging between 20° C. and 100° C., preferably between 30° C. and 90° C., or even between 30° C. and 60° C.

The regeneration stage of the method according to the invention can be carried out by thermal regeneration, optionally complemented by one or more expansion stages.

Regeneration can be carried out at a pressure in C2 ranging between 1 and 5 bars, or even up to 10 bars, and at a temperature in C2 ranging between 100° C. and 180° C., preferably between 130° C. and 170° C. Preferably, the regeneration temperature in C2 ranges between 155° C. and 180° C. in cases where the acid gases are intended to be reinjected. Preferably, the regeneration temperature in C2 ranges between 115° C. and 130° C. in cases where the acid gas is sent to the atmosphere or to a downstream treating process such as a Claus process or a tail gas treating process.

### Example 1

### CO₂ Absorption Capacity

The CO₂ absorption capacity performances of a 1,2-bis(2-dimethylamino-ethoxy)ethane aqueous solution according to the invention in admixture with piperazine are notably compared with those of a methyldiethanolamine aqueous solution in admixture with piperazine containing the same percentage by weight of tertiary amine and piperazine, known to the person skilled in the art for removing CO₂ in natural gas treatment. They are also compared with those of 1,2-bis(2-diethylaminoethoxy)ethane and 1,2-bis(2-pyrolidinoethoxy)ethane aqueous solutions, which are molecules described in the prior art. These solutions contain the same percentage by weight of tertiary amine and piperazine.

An absorption test is carried out on aqueous amine solutions in a perfectly stirred closed reactor whose temperature is controlled by a regulation system. For each solution, absorption is conducted in a 50-cm³ liquid volume by injections of pure CO₂ from a reserve. The solvent solution is first evacuated prior to any CO₂ injection. The pressure of the gas phase in the reactor is measured and a global material balance on the gas phase allows to measure the solvent loading α=nbr moles of acid gas/nbr moles of amine.

By way of example, the loadings (α=nbr moles of acid gas/nbr moles of amine) obtained at 40° C. for a CO₂ partial pressure of 3 bars are compared in Table 2 between a 39 wt. % 1,2-bis(2-dimethylaminoethoxy)ethane aqueous absorbent solution containing 6.7 wt. % piperazine according to the invention, a 39 wt. % methyldiethanolamine aqueous absorbent solution containing 6.7 wt. % piperazine, and aqueous absorbent solutions containing 6.7 wt. % piperazine and 39 wt. % 1,2-bis(2-diethylaminoethoxy)ethane and 1,2-bis(2-pyrolidinoethoxy)ethane respectively.

In the case of application in a decarbonation treatment of natural gas, the CO₂ partial pressures are typically centered between 1 and 10 bars with a temperature of 40° C., and it is desired to remove nearly all of the CO₂ with a view to natural gas liquefaction. To compare the various solvents, the maximum cyclic capacity Δα_{LNG,max} expressed in moles of CO₂ per kg of solvent is calculated, considering that the solvent reaches its maximum thermodynamic capacity at the absorption column bottom α_{PPCO2=3bar} and it is totally regenerated under the column top conditions.

Δα_{LNG,max}(α_{PPCO2=3bar})·[A]·10/M

where [A] is the total amine concentration expressed in wt. % and, in the case of amine mixtures, M is the average molar mass of the amine mixture in g/mol:

M=[A_{T}]/([A_{T}]/M_{AT}+[PZ]/M_{PZ}),

where [A_{T}], [PZ] are the tertiary amine and piperazine concentrations respectively, expressed in wt. %, M_{AT} and M_{PZ} are the tertiary amine and piperazine molar masses respectively, expressed in mol/kg.

α_{PPCO2=3bar} is the loading (mole CO₂/mole amine) of the solvent at equilibrium with a CO₂ partial pressure of 3 bars.

TABLE 2

| | | α_{PPCO2=3bar} | Δα_{LNG, max} |
|---|---|---|---|
| | T | (mol_{CO2}/mol | (mol_{CO2}/kg |
| Solvent | (° C.) | amine) | Solvent) |
| 39 wt. % MDEA + 6.7 wt. % | 40 | 0.88 | 3.57 |
| piperazine (reference) | | | |
| 39 wt. % 1,2-bis(2-diethyl- | 40 | 1.56 | 3.54 |
| aminoethoxy)ethane + | | | |
| 6.7 wt. % piperazine (prior art) | | | |
| 39 wt. % 1,2-bis(2-pyrolidino- | 40 | 1.53 | 3.52 |
| ethoxy)ethane + | | | |
| 6.7 wt. % piperazine (prior art) | | | |
| 39 wt. % 1,2-bis-(2-dimethyl- | 40 | 1.53 | 4.12 |
| aminoethoxy)ethane + | | | |
| 6.7 wt. % piperazine | | | |
| (according to the invention) | | | |

For application in a total decarbonation treatment of natural gas, this example illustrates the higher cyclic capacity obtained using the aqueous absorbent solution according to the invention, comprising 39 wt. % 1,2-bis(2-dimethylaminoethoxy)ethane according to the invention and 6.7 wt. % piperazine in relation to the reference formulation containing 39 wt. % MDEA and 6.7 wt. % piperazine.

An unexpected gain in terms of cyclic capacity of the formulation according to the invention is also observed in relation to the formulation containing 39 wt. % 1,2-bis(2-diethylaminoethoxy)ethane and 6.7 wt. % piperazine, also claimed in document FR-2,961,114.

This example thus illustrates that the diaminoethers claimed in patent U.S. Pat. No. 4,405,582 and more specifically the diaminoethers belonging to the 1,2-bis(2-aminoethoxy)ethane family claimed in document FR-2,961,114 are not equivalent in terms of CO₂ absorption capacity in heavily CO₂-laden gaseous effluents. Unlike other molecules mentioned in these patents, 1,2-bis(2-dimethylamino-ethoxy)ethane allows significant capacity gains to be obtained in relation to a methyldiethanolamine-based reference formulation.

### Example 2

### COS Absorption Kinetics

A comparative COS absorption test is carried out with absorbent solutions according to the invention containing, on the one hand, in aqueous solution, a 40 wt. % tertiary monoamine (methyldiethanolamine here) activated by 3.3 wt. % piperazine and, on the other hand, an aqueous amine solution containing 30 wt. % 1,2-bis(2-dimethylaminoethoxy)ethane prepared according to the invention and activated by 3.3 wt. % piperazine.

For each test, the COS stream absorbed by the aqueous solution is measured in a closed reactor of Lewis cell type. 200 g solution are fed into the closed reactor whose temperature is set at 40° C. Four successive carbon oxysulfide injections are carried out at a pressure from 100 to 200 mbar in the vapour phase of the 200 cm³-volume reactor. The gas phase and the liquid phase are stirred at 100 rpm and entirely characterized from the hydrodynamic point of view. For each injection, the carbon oxysulfide absorption rate is measured through pressure variation in the gas phase. A global transfer coefficient Kg is thus determined using a mean of the results obtained for the 4 injections.

The results obtained are shown in the table hereafter in relative absorption rate by comparison with the 40 wt. % methyldiethanolamine reference formulation activated by 3.3 wt. % piperazine, this relative absorption rate being defined by the ratio of the global transfer coefficient of the solvent to the global transfer coefficient of the reference formulation.

| Composition of the aqueous absorbent liquid | | | | |
|---|---|---|---|---|
| Amine | | Activator | | |
| | Concen- | | Concen- | COS relative |
| | tration | | tration | absorption |
| Nature | (wt. %) | Nature | (mol/kg) | rate |
| MDEA | 40 | piperazine | 0.38 | 1.00 |
| 1,2-bis(2- | 40 | piperazine | 0.38 | 1.23 |
| dimethylamino- | | | | |
| ethoxy)ethane | | | | |

These results highlight, under the test conditions, a 23% higher COS absorption rate with the 1,2-bis(2-dimethylaminoethoxy)ethane-based formulation in relation to the reference MDEA+piperazine formulation. This increase in terms of COS absorption rate allows an unexpected gain to be achieved with the method according to the invention.

### Example 3

### CO₂ Absorption Rate of an Activated Formulation

Two CO₂ absorption tests are carried out with absorbent solutions comprising in aqueous solution a tertiary monoamine (methyldiethanolamine here) for the first test, and 1,2-bis(2-dimethylaminoethoxy)ethane according to the invention for the second test. The formulations of these tertiary amines are 39 wt. % with the same mass concentration of piperazine, i.e. 6.7 wt. %.

In each test, a CO₂-containing gas is contacted with the absorbent liquid in a vertical falling film reactor provided, in the upper part thereof, with a gas outlet and a liquid inlet and, in the lower part thereof, with a gas inlet and a liquid outlet. A gas containing 10% CO₂ and 90% nitrogen is injected through the gas inlet at a flow rate ranging between 30 and 50 Nl/h, and the absorbent liquid is fed to the liquid inlet at a flow rate of 0.5 l/h. A CO₂-depleted gas is discharged through the gas outlet and the CO₂-enriched liquid is discharged through the liquid outlet.

The absolute pressure and the temperature at the liquid outlet are 1 bar and 40° C. respectively.

For each test, the CO₂ stream absorbed between the gas inlet and outlet is measured as a function of the incoming gas flow rate: for each gas flow rate setpoint: 30-35-40-45-50 Nl/h, the incoming and outgoing gas is analyzed using techniques measuring the infrared radiation absorption in the gas phase so as to determine the CO₂ content thereof. The global transfer coefficient Kg characterizing the absorption rate of the absorbent liquid is deduced from all these measurements by carrying out two increase-decrease cycles over the entire range of flow rates.

The operating conditions specific to each test and the results obtained are given in the table below.

| Composition of the aqueous absorbent solution | | | | |
|---|---|---|---|---|
| Tertiary amine | | Activator | | |
| | Concen- | | Concen- | CO₂ relative |
| | tration | | tration | absorption |
| Nature | (wt. %) | Nature | (wt. %) | rate |
| MDEA | 39 | Piperazine | 6.7 | 1 |
| 1,2-bis(2- | 39 | Piperazine | 6.7 | 1.36 |
| dimethylamino- | | | | |
| ethoxy)ethane | | | | |

The results shown in the above table highlight the improved CO₂ absorption rate of the absorbent solutions according to the invention in relation to those of the reference absorbent solution containing an MDEA-piperazine mixture known to the person skilled in the art, an improvement that allows an unexpected gain to be achieved with the method according to the invention.

1. A method for removing acid compounds contained in a gaseous effluent having a CO₂ partial pressure greater than 200 mbar, wherein an acid compound absorption stage is carried out by contacting the effluent with an absorbent solution comprising:
a—water,
b—the diamine 1,2-bis(2-dimethylaminoethoxy)ethane,
c—at least one activator selected from among the amines comprising at least one primary or secondary function.

2. A method as claimed in claim 1, wherein the acid compound absorption stage is carried out at a pressure ranging between 1 bar and 120 bars, and at a temperature ranging between 20° C. and 100° C.

3. A method as claimed in claim 1 wherein, after the absorption stage, a gaseous effluent depleted in acid compounds and an absorbent solution laden with acid compounds are obtained, and at least one stage of regenerating the absorbent solution laden with acid compounds is performed.

4. A method as claimed in claim 3, wherein the regeneration stage is carried out at a pressure ranging between 1 bar and 10 bars, and at a temperature ranging between 100° C. and 180° C.

5. A method as claimed in claim 1, wherein the gaseous effluent is selected from among natural gas, syngas, combustion fumes, refinery gas, biomass fermentation gas, cement plant gas and incinerator fumes.

6. A method as claimed in claim 1, implemented for selective H₂S removal from a gaseous effluent comprising H₂S and CO₂.

7. A method as claimed in claim 1, wherein the absorbent solution comprises between 10 and 90 wt. % of said diamine, preferably between 20 and 60 wt. %, more preferably between 25 and 50 wt. %.

8. A method as claimed in claim 1, wherein the absorbent solution comprises between 10 and 90 wt. % of water, preferably between 40 and 80 wt. %, more preferably between 50 and 75 wt. %.

9. A method as claimed in claim 1, wherein the absorbent solution comprises between 10 and 90 wt. % of 1,2-bis(2-dimethylaminoethoxy)ethane, preferably between 20 and 60 wt. %, more preferably between 25 and 50 wt. %.

10. A method as claimed in claim 1, wherein the absorbent solution has a concentration of less than 30 wt. % of said activator, preferably less than 15 wt. %, preferably less than 10 wt. % and at least 0.5 wt. %.

11. A method as claimed in claim 1, wherein said activator is selected from among:
monoethanolamine,
N-butylethanolamine,
aminoethylethanolamine,
diglycolamine,
piperazine,
1-methylpiperazine,
2-methylpiperazine,
N-(2-hydroxyethyl)piperazine,
N-(2-aminoethyl)piperazine,
morpholine,
3-(methylamino)propylamine,
1,6-hexanediamine and all the diversely N-alkylated derivatives thereof such as, for example, N,N′-dimethyl-1,6-hexanediamine, N-methyl-1,6-hexanediamine or N,N′,N′-trimethyl-1,6-hexanediamine.

12. A method as claimed in claim 1, wherein the absorbent solution comprises an additional amine, said additional amine being a tertiary amine such as methyldiethanolamine, or a secondary amine having two tertiary carbons at nitrogen alpha position, or a secondary amine having at least one quaternary carbon at nitrogen alpha position.

13. A method as claimed in claim 12, wherein the absorbent solution comprises between 10 and 90 wt. % of said additional amine, preferably between 10 and 50 wt. %, more preferably between 10 and 30 wt. %.

14. A method as claimed in claim 1, wherein the absorbent solution comprises a physical solvent selected from among methanol and sulfolane.
